(19) United States
(12) Patent Application Publication
(10) Pub. No.: US 2004/0250658 A1
(43) Pub. Date: Dec. 16, 2004

(54) Spoke wrench

(76) Inventor: Wen-Ying Liao, Changhua Hsien (TW)

Correspondence Address: CHARLES E. BAXLEY, ESQ., 90 JOHN STREET, THIRD FLOOR, NEW YORK, NY, 10038, US

(21) Appl. No.: 10/458,812

(22) Filed: Jun. 10, 2003

(51) Int. Cl. B25B 13/00

(52) U.S. Cl. 81/58.2

(57) ABSTRACT

A spoke wrench is provided with a receiving portion at its base body, at the top end of the receiving portion is defined with a notch and at the same thereof a receiving groove and a recess are respectively formed. In the recess a detent is disposed thereof and in the receiving groove is defined with a driving head, the driving head is provided with a notch for corresponding to the spoke of the wheel. The driving head is axially defined with a receiving hole and a square hole respectively, the square hole is corresponding to the spoke nipple of the spoke, a ratchet is defined about the periphery of the driving head for corresponding to the detent of the base board. Such that the base body is allowed to drive the driving head for facilitating the operation by virtue of the engagement of detent with the ratchet of the drive head. On the other hand, based on the simple structure of the engagement between the detent and the ratchet of the driving head, the spoken wrench of the present invention is easy for operation and low cost in production.

### BACKGROUND OF THE INVENTION

1. Field of the Invention

The present invention relates to a spoke wrench, and more particularly to a spoke wrench having simple structure and being easy for operation which is capable of facilitating the assemblage as well as reducing the production cost.

2. Description of the Prior Arts

A conventional spoke wrench is normally provided with an engaging gear for engaging with spokes of a wheel, and then coupled with and driven by a universal coupler, such that the engaging gear is then able to drive and adjust the spoke of the wheel. This method is kind of effective in some ways, however, there are still some disadvantages need to be improved and will be illustrated as follows with reference to the drawing:

As shown in FIG. 1, a conventional spoke wrench comprises an upper and a lower cover 10 and 11, between them an engaging gear 12, two driven gears 13 and a driving gear 14 are disposed respectively. The engaging gear 12 is defined with a notch 15 for engaging with the spoke of wheel. The driving gear 14 is connected to and driven by a universal joint 16, and then through the driven gear 13 the engaging gear 12 is driven to rotate, so as to adjust the spoke of the wheel. The above description is about structure of a conventional spoke wrench and its working principle, here are the disadvantages of it will be illustrated as follows:

Since, in operation, the user has to hold the upper and lower cover 10, 11 of the conventional spoke wrench with one hand, and meanwhile with another hand rotating the universal joint 16, so as to effect the rotation of the engaging gear 12 and enable the same to adjust the spoke of the wheel. Moreover, in adjusting process, the user has to confirm the tightness of the spoke being adjusted with his/her hand, such that give rise to inconveniences in operation. On the other hand, due to the conventional spoke wrench comprises a universal joint 16 serves to drive the driving gears 14, and indirectly drive the engaging gear 12 through the driven gear 13 so as to adjust the spoke of the wheel, accordingly the conventional spoke wrench is complicated in structure as well as in assemblage, the production cost of which is accordingly increased.

The present invention has arisen to mitigate and/or obviate the afore-described disadvantages of the conventional spoke wrench.

### SUMMARY OF THE INVENTION

The primary object of the present invention is to provide a spoke wrench, in which, when the detent engages in a side of the ratchet of the driving head, this side rotation of the driving head will be limited and stopped, at this moment, this side rotation of the driving head may be effected by pushing the handle of the base body with one hand, so as to adjust the spoke of the wheel effectively and easily.

Another object of the present invention is to provide a spoke wrench, in which, since by virtue of the cooperation between the ratchet of the driving head and the detent in the recess of the base body the spoke wrench of the present invention achieves the above-mentioned function of adjusting the spoke of the wheel without need of the complicated parts of the conventional spoke wrench, the structure of the present invention is exactly simple than that of the convention spoke wrench, which is not only capable of facilitating the assemblage but reducing the production cost as well.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of a conventional spoke wrench;

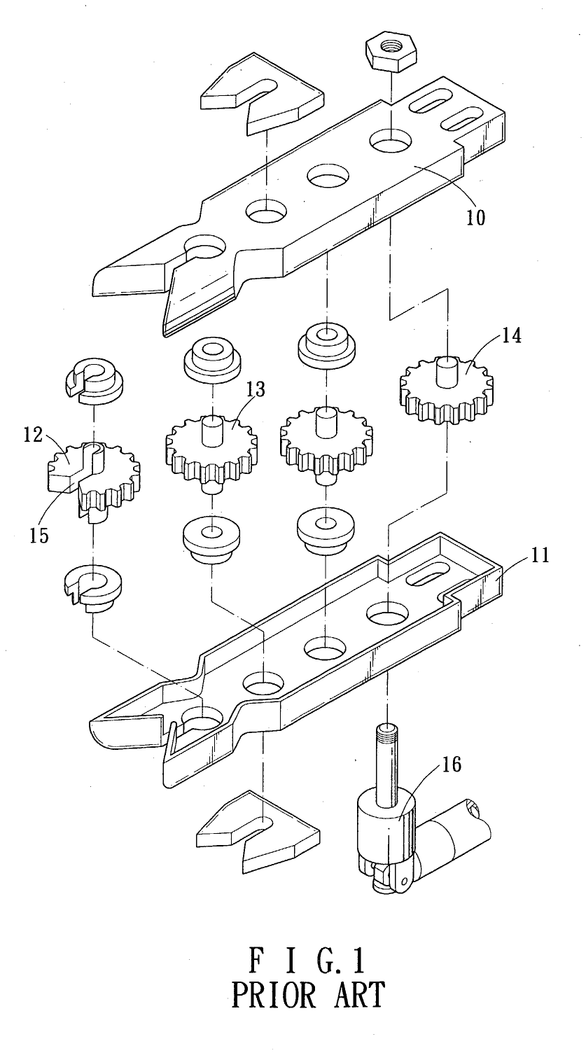

FIG. 2 is an exploded view of a spoke wrench in accordance with the present invention;

FIG. 3 is a perspective view of the spoke wrench in accordance with the present invention;

FIG. 4 is an illustrative view of the spoke wrench in accordance with the present invention, wherein a spoke is being adjusted;

FIG. 5 is a perspective view of a driving head in accordance with another embodiment of the present invention;

FIG. 6 is a perspective view of a spoke wrench in accordance with another embodiment of the present invention.

### DETAILED DESCRIPTION OF THE PREFERRED EMBODIMENTS

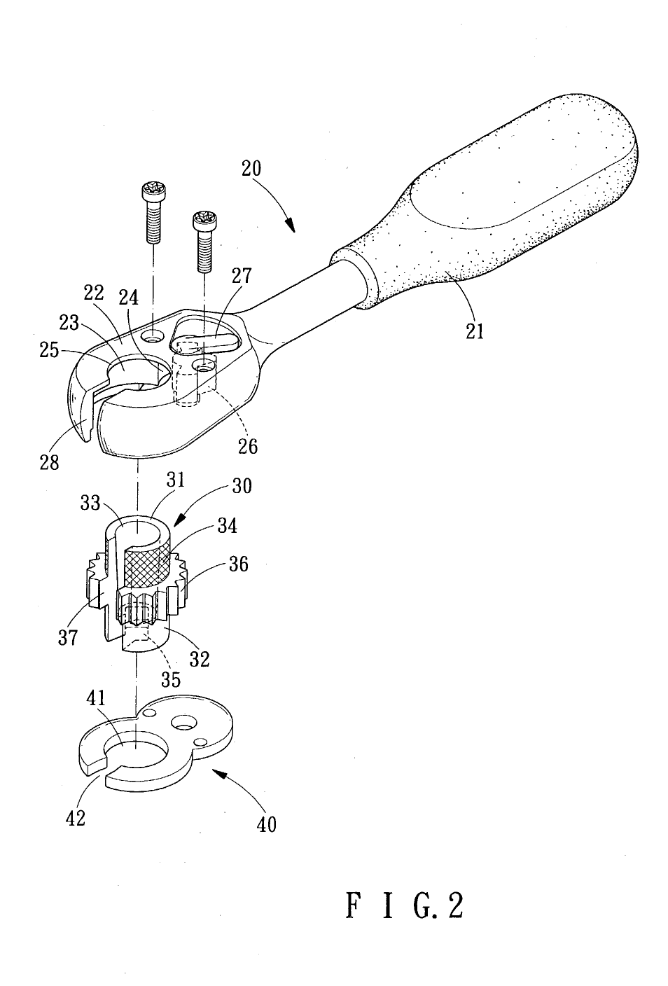

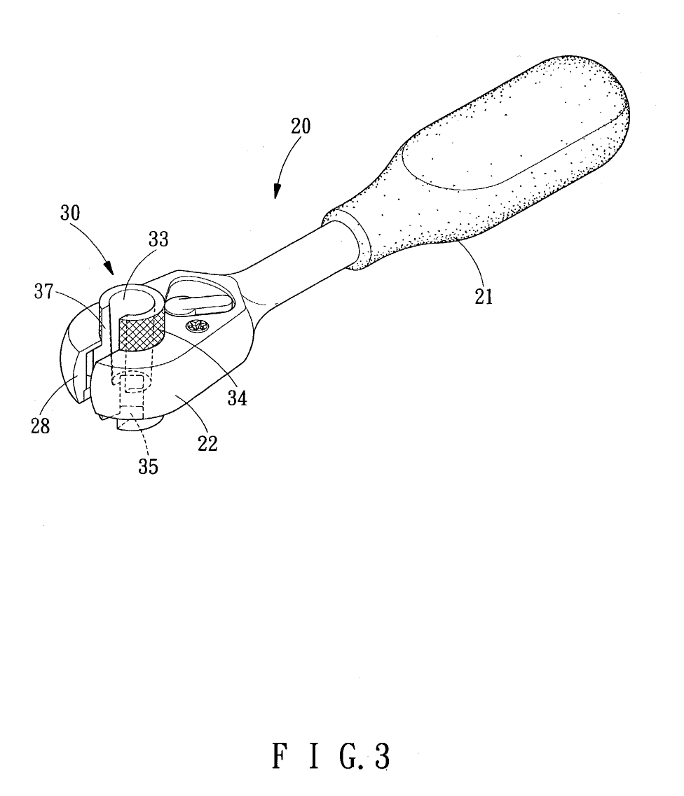

Referring to FIGS. 2-3, a spoke wrench in accordance with the present invention generally comprises a base body 20, a driving head 30 and a cover 40.

The base body 20 has a handle 21 having a receiving portion 22 defined at the front end thereof, at the receiving portion 22 are provided with a receiving groove 23 and a recess 24 respectively, both of which are interconnected. In the receiving groove 23 a hole 25 is defined and in the recess 24 thereof is disposed with a detent 26 for connecting with a rod 27. At the top end of the receiving portion 22 a notch 28 is defined for corresponding to the spoke 51 of the wheel 50.

The driving head 30 has an upper shaft 31 and a lower shaft 32. The upper shaft 31 is provided with a receiving hole 33 for corresponding to the spoke 51 of the wheel 50, about the external periphery of the upper shaft 31 is defined with a plurality of knurls 34. The lower shaft 32 is interiorly formed with a square hole 35 in corresponding to spoke nipple 52 of the spoke 51 of the wheel 50 and connected with the receiving hole 33 of the upper shaft 31. Between the upper and lower shaft 31, 32 a ratchet 36 is annularly defined and to be located in the receiving groove 23 of the receiving portion 22 of the base body 20, which is corresponding to the detent 26 in the recess 24. The upper shaft 31 is installed in hole 25 of the receiving groove 23 of the base body 20 and protrudes out of the outer periphery of the receiving portion 22 of the base body 20. Furthermore, the upper shaft 31, the ratchet 36 and the lower shaft 32 are provided with an interconnected notch 37, which is corresponding to the spoke 51of the wheel 50 and the notch 28 at the receiving portion 22 of the base body 20 respectively.

The cover 40 is disposed in the recess 24 of the receiving groove 23 of the base body 20 and provided with a hole 41 for engaging with the lower shaft 32 of the driving head 30, the lower shaft 32 will protrude out of the outer periphery of the hole 41. At a side of the cover 40 is formed with a gap 42 in corresponding to the spoke 51 of the wheel 50, which is also corresponding to the notch 28 at the receiving portion 22 of the base body 20 and the notch 37 of the driving head 30 respectively.

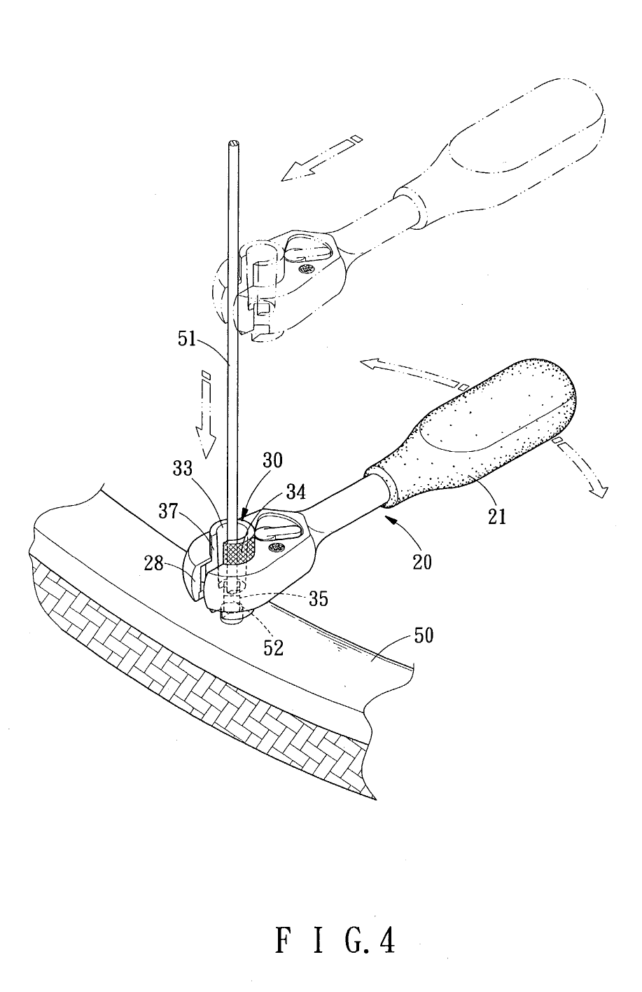

Referring to FIGS. 2 and 4 respectively, in which, due to the notch 28 of the base body 20 and the notch 37 of the driving head 30 are corresponding to the spoke 51 of the wheel 50, initially the spoke 51 of the wheel 50 is engaged in the receiving hole 33 and the square hole 35 of the upper and lower shaft 31, 32 respectively, and then make the square hole 35 of the lower shaft 32 of the driving head 30 engage with the spoke nipple 52 of the spoke 51 of the wheel 50. Meanwhile, due to the ratchet 36 of the driving head 30 is disposed in the receiving groove 23 of the receiving portion 22 of the base body 20, and which is corresponding to the detent 26 in the recess 24 of the base body 20, in this case, when the detent 26 engages in the right side of the ratchet 36 of the driving head 30, the counterclockwise rotation of the driving head 30 will be limited and stopped, at this moment, the clockwise rotation of the driving head 30 may be effected by pushing the handle 21 of the base body 20 with one hand, so as to clockwise adjust the spoke 51 of the wheel 50. Vise versa, when the detent 26 engages in the left side of the ratchet 36 of the driving head 30, which will limit the clockwise rotation of the driving head 30, at the moment, the driving head 30 can be driven to rotate counterclockwise by pushing the handle 21 of the base body 20 with one hand, such that the spoke 51 of the wheel 50 can be counterclockwise adjusted. Since the notch 37 of the driving head 30 will be adjusted in rotating direction in operation, it only needs to drive the driving head 30 by holding the knurling portion 34 of the upper shaft 31 so as to make the notch 37 of the driving head 30 align with the notch 28 in the receiving portion 22 of the base body 20, thus the spoke wrench of the present invention may be taken off the spoke 51 of the wheel 50. Thereby, in operation, the user only needs to push the handle 21 of the base body 20 with one hand, meanwhile, by taking advantage of the adjustment on engaging position of the detent 26 of the base body 20 with respect to the ratchet 36, the spoke wrench of the present invention is then able to adjust the tightness of the spoke 51 of the wheel 50 and achieve the purpose of easy operation. In addition, since by virtue of the cooperation between the ratchet 36 of the driving head 30 and the detent 26 in the recess 24 of the base body 20 the spoke wrench of the present invention achieves the above-mentioned function of adjusting the spoke 51 of the wheel 50 without need of the complicated parts of the conventional spoke wrench, such as an engaging gear, two driven gears, a driving gear and a universal joint, the structure of the present invention is exactly simple than that of the convention spoke wrench, which not only facilitates the assemblage but reduces the production cost as well.

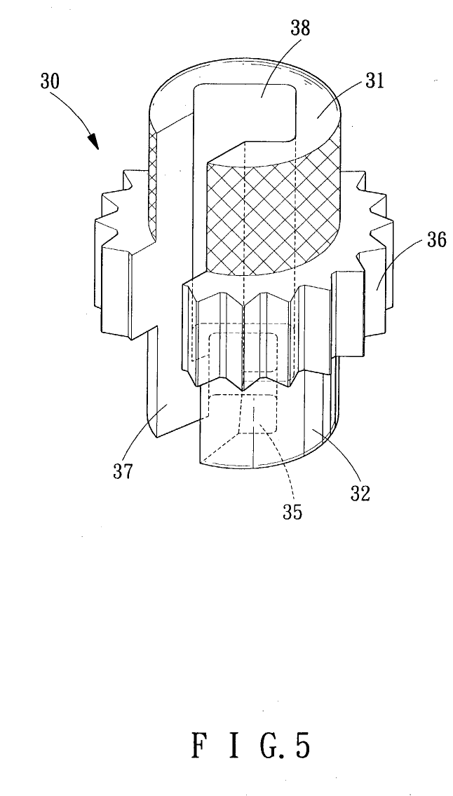

Referring to FIG. 5, in which, the receiving hole 33 in the upper shaft 31 of the driving head 30 can be in form of a square hole 38 having different size from that square hole 35 in the lower shaft 32, which is corresponding to spoke nipple 52 of the spoke 51 of the wheel 50, due to the square hole 38 in the upper shaft 31 is different from that square hole 35 in the lower shaft, the driving head 30 is applicable to two different sized spokes 51 of the wheel 50, so as to facilitate the operation.

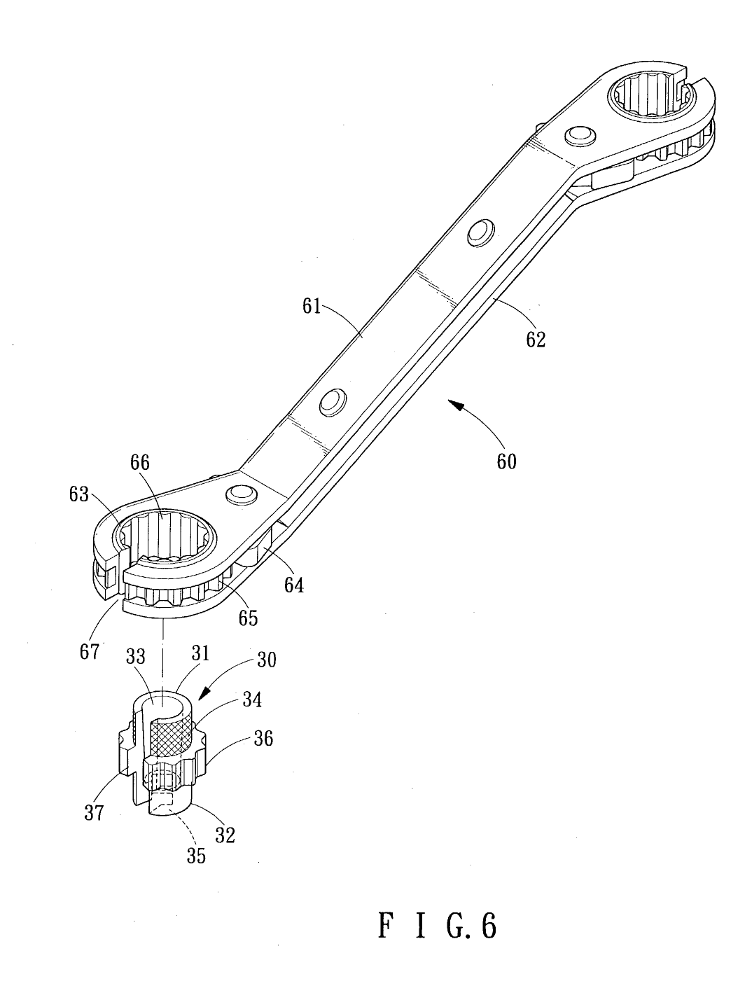

In addition, with reference to FIG. 6, which shows a spoke wrench in accordance with another preferred embodiment of the present invention. Wherein a base body 60 of a double offset ring spanner comprises an upper and a lower cover 61, 62. Between the lower and upper cover 62, 61 are disposed with a ratchet sleeve 63 and a detent 64, the ratchet sleeve 63 is made of magnetic material and at its outer periphery a ratchet 65 is defined in corresponding to the detent 64 (since the cooperation between the ratchet 65 and the detent 64 is identical to above description, further remarks on the matter would seem superfluous), about the internal periphery of the ratchet sleeve 63 a plurality of teeth 66 are defined in corresponding to the ratchet 36 of the driving head 30. At both lower and upper covers 62, 61 of the base body 60 a notch 67 passing through the ratchet sleeve 63 is defined respectively, which is corresponding to the spoke 51 of the wheel 50. Since the ratchet sleeve 63 is made of magnetic material, on which the driving head 30 may be disposed, and make the notch 37 align with that notch 67 of the base body 60, which then can be applied to adjust the spoke 51 of the wheel 50. If want to adjust other different sized spokes 51, it only needs to replace the original driving head 30 in ratchet sleeve 63 of the base body 60 with another driving head 30 having the square holes 35, 38 conformable to the spokes 51 to be operated.

While we have shown and described various embodiments in accordance with the present invention, it should be clear to those skilled in the art that further embodiments may be made without departing from the scope of the present invention.

What is claimed is:

1. A spoke wrench comprising:
a base body having a handle which having a receiving portion defined at the front end thereof, at the receiving portion provided with a receiving groove and a recess respectively, in the receiving groove defined with a hole and in the recess thereof disposed with a detent for connecting with a rod, at the top end of the receiving portion a notch defined for corresponding to the spoke of the wheel;
a driving head including an upper shaft and a lower shaft, the upper shaft provided with a receiving hole in corresponding to the spoke of the wheel, about the external periphery of the upper shaft defined with a plurality of knurls, the lower shaft interiorly formed with a square hole with corresponding to a spoke nipple of the spoke of the wheel and connected with the receiving hole of the upper shaft, between the upper and lower shaft a ratchet annularly defined and to be located in the receiving groove of the receiving portion of the base body, which corresponding to the detent received in the recess, the upper shaft installed in hole of the receiving groove of the base body and protruding out of the outer periphery of the receiving portion of the base body, furthermore, the upper shaft, the ratchet and the lower shaft provided with an interconnected notch with corresponding to the spoke of the wheel and the notch at the receiving portion of the base body;
a cover disposed in the recess of the receiving groove of the base body and provided with a hole for engaging with the lower shaft of the driving head, the lower shaft protruding out of the outer periphery of the hole, at a side of the cover formed with a gap in corresponding to the spoke of the wheel which corresponding to the notch at the receiving portion of the base body and the notch of the driving head.

2. The spoke wrench as claimed in claim 1, wherein the receiving hole in the upper shaft of the driving head can be in form of a square hole which is different sized from that square hole in the lower shaft, by such manner, the driving head is applicable to two different sized spokes.

3. The spoke wrench as claimed in claim 1, wherein the base body is composed of an upper and a lower cover of a double offset ring spanner, between the lower and upper cover disposed with a ratchet sleeve and a detent, the ratchet sleeve is made of magnetic material and at its outer periphery a ratchet is defined and corresponding to the detent, about the internal periphery of the ratchet sleeve a plurality of teeth defined corresponding to the ratchet of the driving head, at both lower and upper covers of the base body a notch passes through the ratchet sleeve being defined respectively, which corresponding to the spoke of the wheel.
